(19) United States
(12) Patent Application Publication
(10) Pub. No.: US 2025/0182001 A1
(43) Pub. Date: Jun. 5, 2025

(54) ETHICALITY DIAGNOSIS DEVICE AND ETHICALITY DIAGNOSIS METHOD

(71) Applicant: HITACHI SOLUTIONS, LTD., Tokyo (JP)

(72) Inventors: Daisuke Fukui, Tokyo (JP); Ryo Soga, Tokyo (JP); Emi Saito, Tokyo (JP); Masahiko Inoue, Tokyo (JP); Naoya Ishida, Tokyo (JP); Hideto Yamamoto, Tokyo (JP); Koki Kumazawa, Tokyo (JP)

(73) Assignee: HITACHI SOLUTIONS, LTD., Tokyo (JP)

(21) Appl. No.: 18/845,929

(22) PCT Filed: Jan. 13, 2023
(86) PCT No.: PCT/JP2023/000723

§ 371 Date: Sep. 11, 2024

(30) Foreign Application Priority Data
May 10, 2022 (JP) 2022-077775

(51) Int. Cl. G06Q 10/04; G06N 20/00

(52) U.S. Cl. CPC G06Q 10/04; G06N 20/00

(57) ABSTRACT

An object of the invention is to appropriately diagnose ethicality of a prediction result of an AI model. An ethicality diagnosis device stores sensitive feature data, which is data that associates a value of a sensitive feature, which is a feature required to take a certain consideration in handling from a perspective of the ethicality with a value of a selected feature, which is one or more features selected from a feature constituting the AI model, a sensitive feature coefficient, and a per-feature importance level, and obtains, based on the sensitive feature coefficient and the per-feature importance level, a non-ethical degree, which is a value indicating a degree of ethicality of the prediction result output by the AI model.

### BACKGROUND

### Technical Field

The present invention relates to an ethicality diagnosis device and an ethicality diagnosis method.

### Background Art

The present application is a U.S. National Phase Application under 35 U.S.C. § 371 of International Application No. PCT/JP2023/000723, filed Jan. 13, 2023 which claims priority from JP Application Serial Number 2022-077775, filed May 10, 2022, the disclosure of both of which is hereby incorporated by reference herein in their entireties.

In recent years, systems using an AI model (AI: artificial intelligence) have been used in various fields. Meanwhile, it is a problem to ensure ethicality and fairness of the AI model. For example, when training data used for training the AI model is tainted by prejudices or gaps due to gender, age, race, ethnicity, or the like (i.e., if there is a bias in the training data), output of the AI model will also be influenced by these prejudices and gaps.

Regarding the ethicality of AI models, for example, PTL 1 discloses an evaluation device implemented for the purpose of efficiently and reliably evaluating a risk of a model installed in a white-box AI system and an analysis engine. The evaluation device acquires one or more prediction models that can be described, determines a risk of one or more models based on the one or more models and ethical risk factor information, which is information that becomes an ethical risk factor, and selects and outputs a model based on a determination result of the determined risk. The evaluation device generates, based on a relationship between elements of the one or more models, a sentence in which a model is described in a language for each of the one or more models, and determines the risk of the one or more models by using at least one of the sentence and the elements of the sentence and the ethical risk factor information.

In addition, NPL 1 discloses a tool created based on the premise that there is a chance that directivity of training greatly changes when the AI is trained using training data based on performance or tendency that is more biased (i.e., there is bias) due to a habit or a historical background. In the document, by using the tool described above, an investigation, a report, and a reduction in prejudices (bias) caused by attributes such as race, gender, region, and age, which are included in the result derived by AI, are achieved.

### CITATION LIST

### Patent Literature

PTL 1: WO2021/199201

### Non-Patent Literature

NPL 1: IBM Research Trusted AI, “AI Fairness 360”, [online], Mar. 24, 2022, IBM Research & IBM, [Mar. 24, 2022], internet, URL: aif360.res.ibm.com/SUMMARY OF INVENTION

### Technical Problem

The risk evaluation device described in PTL 1 generates the sentence representing the relationship between an explanatory variable and an objective variable of the model, obtains a similarity between characteristics of the generated sentence and characteristics of the ethical risk factor information, and evaluates an ethical risk based on a frequency of those having a predetermined similarity. The technique described in NPL 1 provides a tool for reducing bias in training data, a model during training, and a predicted label. However, the technique described in any document is a mechanism in which the ethicality is evaluated before or after the model is applied to an actual usage situation, and the ethicality of a prediction result output by the model in the actual usage situation is not immediately evaluated.

In addition, the tool described in NPL 1 has a function that freely changes the prediction result output by the AI model, and using this function may lead to a decrease in quality of the model. It is difficult to completely remove the impact of bias, and the tool described in NPL 1 does not guarantee that the prediction result output by the AI model does not include an ethical problem.

The present invention has been made in view of such a background, and an object thereof is to provide an ethicality diagnosis device and an ethicality diagnosis method capable of appropriately diagnosing ethicality of a prediction result output by an AI model.

### Solution to Problem

In order to achieve the above object, one aspect of the invention is an ethicality diagnosis device for diagnosing ethicality of a prediction result of an AI model. The device includes an information processing device including a processor and a storage device. The information processing device stores sensitive feature data, which is data that associates a value of a sensitive feature, which is a feature required to take a certain consideration in handling from a perspective of the ethicality, with a value of a selected feature, which is one or more f features selected from a feature of the AI model; a sensitive feature coefficient, which is a value indicating a degree of impact of each of the selected features on the sensitive feature, which is obtained by analyzing a relationship between the value of the sensitive feature and the value of the selected feature; and a per-feature importance level, which is a value indicating a degree of impact of each of the selected features on a prediction result of the AI model, and obtains, based on the sensitive feature coefficient and the per-feature importance level, a non-ethical degree, which is a value indicating a degree of ethicality of the prediction result output by the AI model.

Other problems disclosed by the present application and methods for solving the problems will be made clear by the detailed description and drawings.

### Advantageous Effects of Invention

According to the invention, it is possible to appropriately diagnose ethicality of a prediction result output by an AI model.

### BRIEF DESCRIPTION OF DRAWINGS

FIG. 1 is a diagram showing an example of main functions of an ethicality diagnosis device.

FIG. 2 is a system flow diagram showing an example of the main functions of the ethicality diagnosis device.

FIG. 3 is a diagram showing an example of S feature data.

FIG. 4 is a diagram showing an example of a result obtained by logistic regression analysis.

FIG. 5 is an example of a prediction/diagnosis result presentation screen.

FIG. 6 is an example of a per-S-feature detailed diagnosis screen.

FIG. 7 is an example of an information processing device used for a configuration of the ethicality diagnosis device.

### DESCRIPTION OF EMBODIMENTS

Hereinafter, an embodiment of the invention will be described in detail with reference to the drawings as appropriate. In the following description, various data may be described using expressions such as “information” and “data”, and the various kinds of data may be expressed or managed in a manner other than a data structure shown as an example.

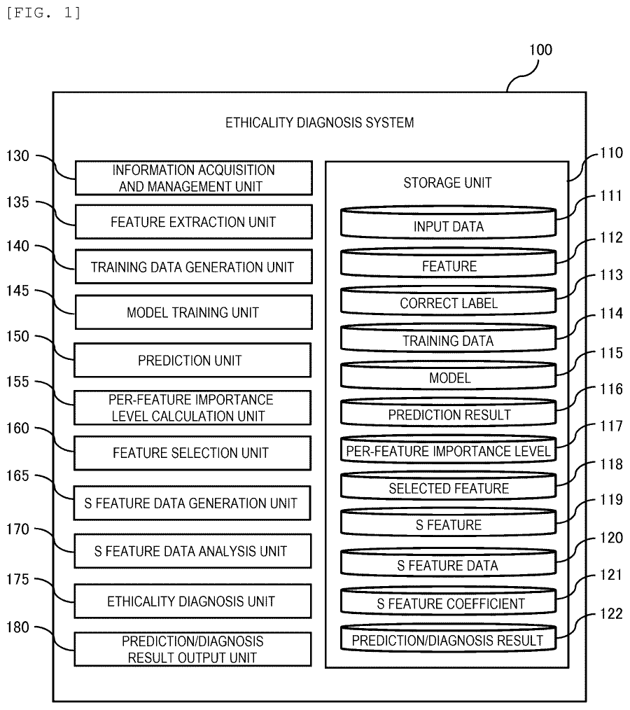

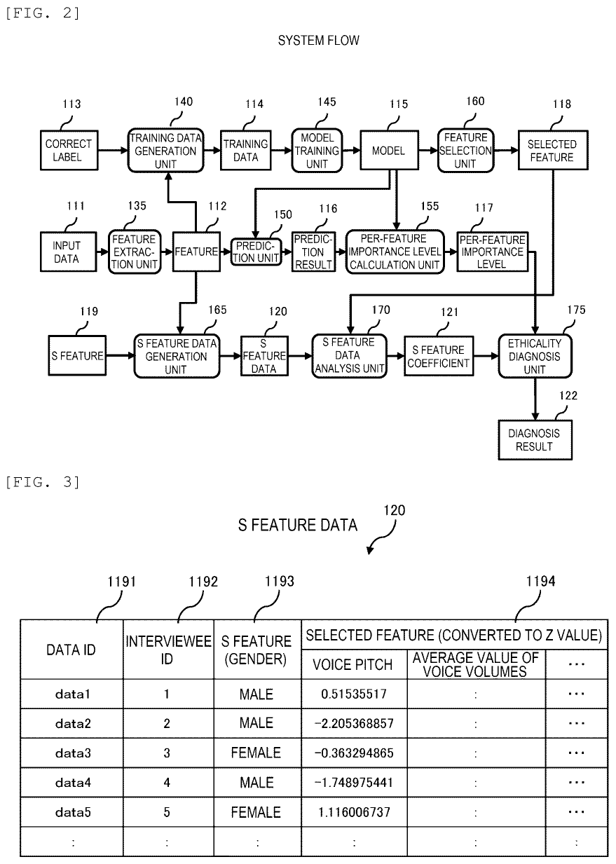

FIG. 1 is a block diagram showing main functions of a system (hereinafter, referred to as an “ethicality diagnosis device 100”) that diagnoses ethicality of a prediction result output by an AI model (i.e., a machine learning model; hereinafter referred to as a “model”) as one embodiment. FIG. 2 is a system flow diagram showing the main functions of the ethicality diagnosis device 100. The ethicality diagnosis device 100 is implemented using one or more information processing devices (computers). The main functions of the ethicality diagnosis device 100 will be described below with reference to the drawings.

In the embodiment, an example will be described in which a model to be diagnosed is a model that outputs information (hereinafter, referred to as “evaluation information”) related to an evaluation of a skill of an interviewee by inputting features (voice pitch, voice volume, line-of-sight direction, facial expression, nod frequency, heart rate, and the like) extracted from video data obtained by imaging a state of an interview conducted with an applicant of a company (hereinafter, referred to as the “interviewee”).

The ethicality diagnosis device 100 diagnoses the ethicality of a prediction result output by the model by focusing on features that require a certain degree of consideration in handling from a perspective of ethicality (for example, race, gender, nationality, age, employment type, a place of origin, residence, gender minority, religion, physical/intellectual disability, and ideology; hereinafter, referred to as a “sensitive feature” or an “S feature”).

As shown in FIG. 1 or 2, the ethicality diagnosis device 100 includes functions of a storage unit 110, an information acquisition and management unit 130, a feature extraction unit 135, a training data generation unit 140, a model training unit 145, a prediction unit 150, a per-feature importance level calculation unit 155, a feature selection unit 160, an S feature data generation unit 165, an S feature data analysis unit 170, an ethicality diagnosis unit 175, and a prediction/diagnosis result output unit 180.

Among the functions described above, the storage unit 110 stores information (data) on input data 111, a feature 112, a correct label 113, training data 114, a model 115, a prediction result 116, a per-feature importance level 117, a selected feature 118, an S feature 119, S feature data 120, an S feature coefficient 121, and a prediction/diagnosis result 122.

Among these, the input data 111 is data serving as an extraction source of the feature 112 to be input to the model 115. In the embodiment, as an example, it is assumed that the input data 111 is video data obtained by imaging a state of an interviewee.

The feature 112 is the feature 112 extracted by the feature extraction unit 135 from the input data 111. In the embodiment, the feature 112 is, for example, a “voice pitch”, a “voice volume”, “number of times of deviation of line of sight”, an “average heart rate”, a “variance of nodding frequency”, and a “minimum value of surprise emotion” of the interviewee. The feature 112 is used to generate the training data 114 in addition to a case in which the feature 112 is given to the model 115 in an actual usage situation of the model 115. The feature 112 in the former case is, for example, a feature extracted from the video data obtained by imaging the state of the interviewee, and the feature 112 in the latter case is, for example, a feature extracted from the video data of another interviewee imaged in the past.

The correct label 113 is a correct label of the evaluation information to be given to the feature 112 when the training data 114 is generated. In the embodiment, the correct label 113 is, for example, a numerical value indicating a level of the skill of the interviewee.

The training data 114 is data (labeled data) used for training the model 115. The training data 114 is generated by adding the correct label 113 to sample data of the feature 112 (a value of each feature 112 generated based on the input data 111).

The model 115 is a machine learning model that outputs a result of training based on the training data 114 as the prediction result 116 based on the input feature 112. In the embodiment, the model 115 outputs, for example, an evaluation score (for example, an evaluation score according to a five-level evaluation) of the interviewee for each evaluation item (for example, a level of listening, the voice volume, an ability to understand questions, the line of sight, and the facial expression) set in advance as the evaluation information. A type of the model 115 is not limited, and is, for example, regression (linear regression, logistic regression, support vector machine, or the like), trees (decision tree, random forest, gradient boosting, or the like), or a neural network (convolutional neural network or the like).

The prediction result 116 is information output by the model 115 in response to the value of the input feature 112. In the embodiment, the prediction result 116 is, for example, an evaluation score for each of the evaluation items of the interviewee.

The per-feature importance level 117 is a value indicating a degree of impact of each of the features 112 on the prediction result 116. A method for calculating the per-feature importance level 117 will be described later.

The selected feature 118 is a feature selected by the feature selection unit 160 from the feature 112 given to the model 115. The selected feature 118 is used to generate the S feature data 120.

The S feature 119 is the S feature described above.

The S feature data 120 is data in which values of one or more selected features 118 are associated with the S feature.

The S feature coefficient 121 is a value indicating a degree of impact of each of the selected features 118 on the S feature.

The prediction/diagnosis result 122 is information related to a result of diagnosing the ethicality of the prediction result output from the model 115 by the ethicality diagnosis unit 175. As will be described later, the ethicality diagnosis unit 175 obtains a value (index) (hereinafter, referred to as a “non-ethical degree”) indicating a degree of ethicality of the prediction result output by the model 115 based on the per-feature importance level 117 and the S feature coefficient 121, and outputs the calculated non-ethical degree and information based on the non-ethical degree as the prediction/diagnosis result 122.

The information acquisition and management unit 130 shown in FIG. 1 acquires, via a user i interface, a communication network, or the like, various kinds of information (the input data 111, the correct label 113, a designation of the selected feature 118 (or a selection criterion), the S feature 119, and the like) used for the diagnosis of the ethicality of the prediction result output by the model 115, and manages the acquired information in the storage unit 110.

The feature extraction unit 135 extracts the feature 112 from the input data 111. A method for extracting the feature 112 is not necessarily limited. In the embodiment, the feature extraction unit 135 extracts the feature 112 by, for example, analyzing an optical flow acquired from the video data as a main component and identifying a representative feature from a unique value.

The training data generation unit 140 generates the training data 114 by adding the correct label 113 to the feature 112. The correct label 113 is set by a user via, for example, a user interface.

The model training unit 145 trains the model 115 based on the training data 114. For example, the model training unit 145 inputs the value of the feature 112 in the training data 114 to the model 115, compares a value output by the model 115 with the label of the training data 114, and trains the model 115 by adjusting parameters constituting the model 115 based on a difference (by feeding back the difference).

The prediction unit 150 acquires the information output by the model 115 as the prediction result 116 by inputting the feature 112 extracted from the input data 111 (video data) to the model 115 in the actual usage situation of the model 115. The prediction result 116 is provided to, for example, a user such as a human resources officer who screens the interviewee via the user interface.

The per-feature importance level calculation unit 155 calculates the per-feature importance level 117. The method for calculating the per-feature importance level 117 is not necessarily limited, and the per-feature importance level calculation unit 155 calculates the per-feature importance level 117 for using techniques such as “SHapley Additive explanations (SHAP)”, a “Shapley value”, a “Cohort Shapley value”, and “local permutation importance”.

The feature selection unit 160 selects a predetermined number of selected features 118 from the feature 112 extracted by the feature extraction unit 135. The feature selection unit 160 may not only select a part of the feature 112 extracted by the feature extraction unit 135 as the selected feature 118 but also select all of them as the selected feature 118.

The S feature data generation unit 165 generates the S feature data 120 by associating the value of each of the one or more selected features 118 with the value of the S feature. The S feature data generation unit 165 receives, for example, a setting of the S feature associated with the selected feature 118 and a setting of each value from the user via the user interface.

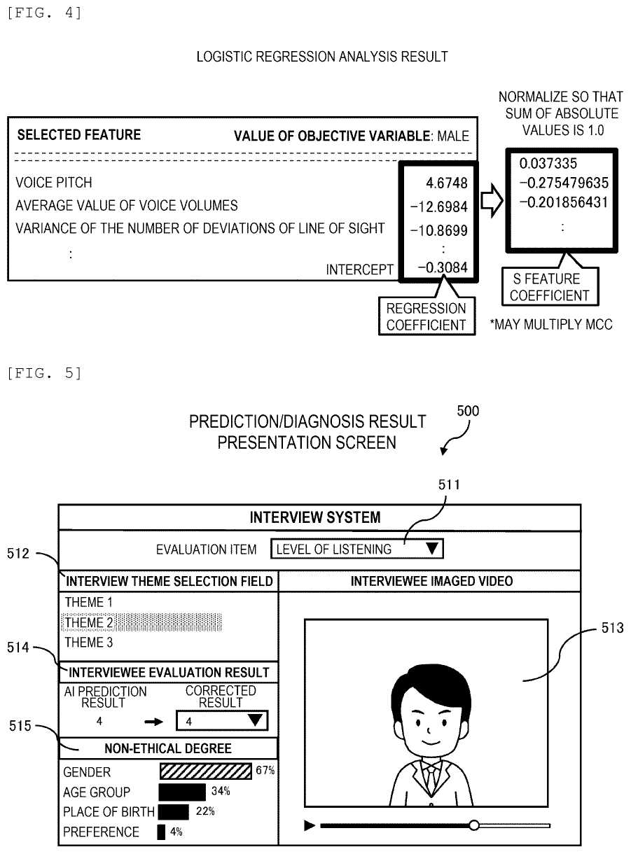

FIG. 3 shows an example of the S feature data 120. The shown S feature data 120 is made of a plurality of records each having an item of a data ID 1191, an interviewee ID 1192, an S feature 1193, and a selected feature 1194. One of the records of the S feature data 120 corresponds to one of the sample data (a combination of values of the selected features) extracted from the input data 111 (video data).

Among the above items, the data ID 1191 stores a data ID which is an identifier of the sample data. The interviewee ID 1192 stores an interviewee ID, which is an identifier of the interviewee. The S feature 1193 stores the value of the S feature described above. The selected feature 1194 stores the value of each of one or more selected features 118 associated with the S feature.

For example, a screen describing contents of FIG. 3 may be generated and displayed via the user interface. A user interface for editing the contents of the screen may be provided, and the user may edit the contents of the S feature data 120.

The S feature data analysis unit 170 shown in FIG. 1 or 2 analyzes the S feature data 120 to obtain the S feature coefficient 121. In the embodiment, the S feature data analysis unit 170 uses the S feature as an objective variable, performs logistic regression analysis using the selected feature (for example, a selected feature normalized to a Z value (average “0”, variance “1”)) as an explanatory variable, and obtains a normalized regression coefficient as the S feature coefficient 121 so that a sum of absolute values is “1.0”.

The number of selected features (explanatory variables) used in the logistic regression analysis is, for example, “ 1/10” of the number of sample data that is the smaller of the numbers of sample data for each of the values that the S feature can take. For example, when the S feature is “gender” and the number of sample data for “male” is “40” and the number of sample data for “female” is “60”, the number of the selected features (explanatory variables) is set to “4”, which is the number of sample data for males “40” (with the fewer number of sample data) multiplied by “ 1/10”.

For example, when multicollinearity is recognized between the selected features (explanatory variables), one selected feature in a correlation relationship may be excluded. For example, the regression analysis using a feature selection algorithm is performed on all the selected features, and when a variance inflation factor (VIF) obtained from the next formula (hereinafter, referred to as “Formula 1”) exceeds a preset threshold value, one selected feature is excluded. In Formula 1, rᵢ is a multiple correlation coefficient (i is a natural number given to each combination of explanatory variables).

$${VIF}_{i} = \frac{1}{1 - {r}_{i}^{2}} \qquad [ Formula 1 ]$$

For comparison, when the logistic regression analysis is performed on the combination (the S feature data 120) of a plurality of S features (objective variables) d selected features (explanatory variables) having different selected features (by changing the selected feature), for example, a Matthews Correlation Coefficient (MCC) may be obtained by cross-validation, and a combination of the largest MCC may be selected from the combinations. In this case, a comparison result of a plurality of combinations may be reflected in the S feature coefficient 121, such as setting a value obtained by integrating the MCC to the normalized regression coefficient as the S feature coefficient 121.

In the embodiment, the degree of impact of the selected feature (explanatory variable) on the S feature (objective variable) is obtained by the logistic regression analysis, and the above degree of impact may be determined by other methods.

FIG. 4 shows an example of the result of the logistic regression analysis. FIG. 4 shows an analysis result when the value of the S feature (objective variable) “gender” is “male”. In this example, the S feature coefficient 121 is normalized such that the sum of the absolute values of the values of the regression coefficients for each selected feature such as the “voice pitch”, the “average value of the voice volume”, and the “variance of the number of deviations of line of sight” obtained by the logistic regression analysis is “1.0”.

For example, a screen displaying the contents of FIG. 4 may be displayed via the user interface so that the user can check the result of the logistic regression analysis.

The ethicality diagnosis unit 175 shown in FIG. 1 or 2 obtains the non-ethical degree based on the per-feature importance level 117 and the S feature coefficient 121, and outputs the non-ethical calculated degree as the prediction/diagnosis result 122. For example, the ethicality diagnosis unit 175 obtains the non-ethical degree as follows.

First, the per-feature importance level is normalized so that the sum of its absolute values is “1.0”. Subsequently, the sum of values obtained by integrating the per-feature importance level and the S feature coefficient is obtained as the non-ethical degree for each prediction result from the following formula (hereinafter, referred to as “Formula 2”).

$${U}_{k} = 100 \times {\sum }_{i = 0}^{n} ( {L}_{i} \times {s}_{i} ) \qquad [ Formula 2 ]$$

In Formula 2, Uₖ is a non-ethical degree (k is an identifier of a prediction result), Lᵢ is a normalized per-feature importance level, sᵢ is an S feature coefficient, i is a natural number for identifying an S feature coefficient (or a per-feature importance level), and n is the number of S feature coefficients (the number of selected features). In order to offset positive and negative impacts (for example, the impact when the S feature is “gender”, the impact when the feature of “male” is emphasized and the impact when the feature of “female” is emphasized), the normalized per-feature importance level and the normalized S feature coefficient are denoted by the value of reference numerals.

The prediction/diagnosis result output unit 180 shown in FIG. 1 or 2 generates and outputs a screen (hereinafter, referred to as a “prediction/diagnosis result presentation screen 500”) describing the content of the prediction result 116 and the content of the prediction/diagnosis result 122 (the ethicality diagnosis result) via the user interface.

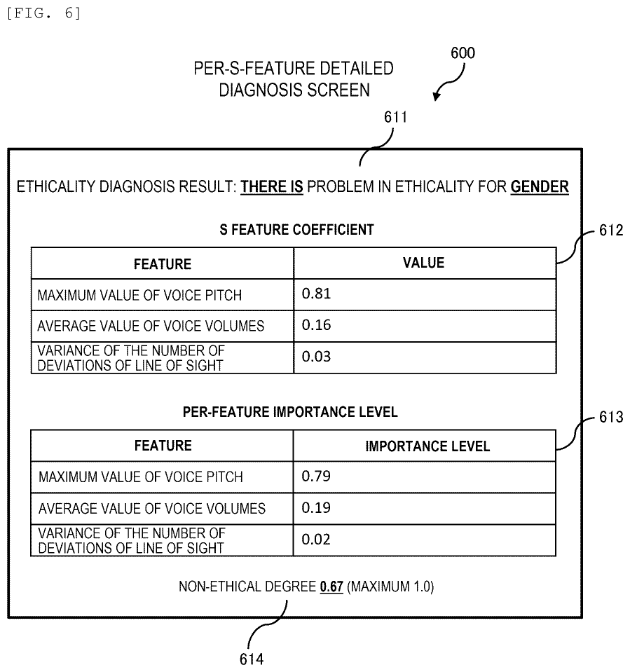

FIG. 5 is an example of the prediction/diagnosis result presentation screen 500. As shown in FIG. 5, the prediction/diagnosis result presentation screen 500 includes an evaluation item selection field 511, an interview theme selection field 512, a video display field 513, an interviewee evaluation result check field 514, and a non-ethical degree display field 515.

In the evaluation item selection field 511, a user such as a human resources officer can select an evaluation item using a pull-down menu. In this example, the user selects the “level of listening”.

In the interview theme selection field 512, the user can select an interview theme by operating a mouse, a keyboard, or the like. In this example, the user selects a “theme 2”.

In the video display field 513, a replay video of video data imaged when an interviewee is interviewed on the interview theme selected by the user in the interview theme selection field 512 is displayed.

In the interviewee evaluation result check field 514, an evaluation result of the interviewee predicted by the prediction unit 150 based on the model 115 is displayed. As shown in FIG. 5, a pull-down menu for correcting the evaluation result is provided in the interviewee evaluation result check field 514, and the user can appropriately correct the evaluation result.

In the non-ethical degree display field 515, a result of diagnosing the ethicality of the prediction result 116 obtained by the ethicality diagnosis unit 175 when the model 115 makes a prediction using the video data displayed in the video display field 513 as the input data 111 (the non-ethical degree for each S feature) is displayed. In this example, the non-ethical degree for each S feature of “gender”, “age group”, “place of birth”, and “directivity” is displayed in bar graph form.

When the user selects one of the S features in the non-ethical degree display field 515, the prediction/diagnosis result output unit 180 generates and outputs a screen (hereinafter, referred to as a “per-S-feature detailed diagnosis screen 600”) describing information on an ethicality determination result of the selected S feature, the S feature coefficient used for calculating the non-ethical degree of the selected S feature, and the per-feature importance level.

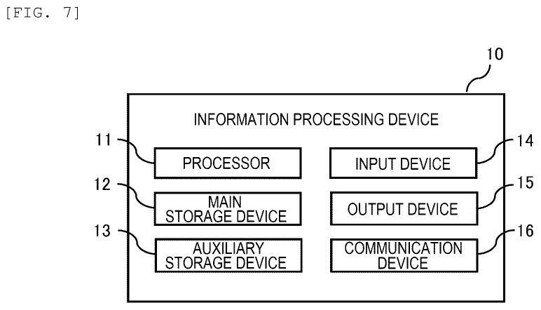

FIG. 6 shows an example of the per-S-feature detailed diagnosis screen 600 displayed when the user selects the S feature “gender” in the non-ethical degree display field 515 of the prediction/diagnosis result presentation screen 500. As shown in FIG. 6, the prediction/diagnosis result presentation screen 500 includes an ethicality diagnosis result display field 611, an S feature coefficient display field 612, a per-feature importance level display field 613, and a non-ethical degree display field 614.

In the ethicality diagnosis result display field 611, the ethicality diagnosis unit 175 displays information indicating the result of diagnosing the ethicality of the prediction result 116 output by the model 115 based on the non-ethical degree. For example, when an ethicality level exceeds a preset threshold value (50% (0.5) in this example), the ethicality diagnosis unit 175 determines that there is a problem with the ethicality of the model 115 for the corresponding S feature. When the value is equal to or smaller than the threshold value, the ethicality diagnosis unit 175 determines that there is no problem with the ethicality of the prediction result 116 for the corresponding S feature. In this example, the non-ethical degree is “0.67” and exceeds the threshold value, and the content indicating the problem with the ethicality of the prediction result 116 is displayed in the ethicality diagnosis result display field 611 for the S feature “gender”.

In the S feature coefficient display field 612, the value of the S feature coefficient 121 used to calculate the non-ethical degree is displayed. In the per-feature importance level display field 613, the value of the per-feature importance level 117 used to calculate the non-ethical degree is displayed. In this example, the ethicality diagnosis unit 175 calculates the non-ethical degree (0.67=0.81×0.79+0.16×0.19+0.03×0.02) by substituting the value of the S feature coefficient 121 and the value of the per-feature importance level 117 of each of the S feature “the maximum value of the voice pitch”, the “average value of the voice volumes”, and the “variance of the number of deviations of line of sight” into Formula 2. In the non-ethical degree display field 614, the value of the non-ethical degree is displayed.

As described above, the ethicality diagnosis device 100 according to the embodiment can appropriately diagnose the ethicality of the prediction result 116 output by the model 115 by obtaining the non-ethical degree, which is a value indicating ethicality of the prediction result 116 output by the model based on the S feature coefficient 121, which is a value indicating the degree of impact of each of the selected features 118 on the S feature 119 and the per-feature importance level 117, which is a value indicating the degree of impact of each of the selected features 118 on the prediction result 116 of the model 115.

According to the ethicality diagnosis device 100 of the embodiment, it is possible to provide the user with an index for determining the presence or absence of an ethicality problem in the prediction result 116 output by the model 115. In addition, even when the prediction result 116 includes a bias, information indicating the presence or absence of the ethicality problem can be provided to the user.

In addition, the ethicality diagnosis device 100 determines the ethicality of the prediction result 116, and does not involve willful change in the prediction result 116, and thus a deterioration in the quality of the model 115 can be prevented.

When the prediction result 116 of the model 115 has an ethicality problem, a warning is output, and thus the user can be reliably informed (made aware) that the prediction result 116 of the model 115 has an ethical problem.

FIG. 7 shows a configuration example of an information processing device constituting the ethicality diagnosis device 100. An information processing device 10 shown includes a processor 11, a main storage device 12, an auxiliary storage device 13, an input device 14, an output device 15, and a communication device 16. The shown information processing device 10 may be implemented, in whole or in part, using a virtual information processing resource provided using a virtualization technique, a process space separation technique, or the like, such as a virtual server provided by a cloud system. Some or all of functions provided by the information processing device 10 may be implemented by, for example, a service provided by a cloud system via an application program interface (API) or the like. The ethicality diagnosis device 100 may be implemented using a plurality of information processing devices 10 communicably connected to each other.

The processor 11 shown in FIG. 7 is implemented using, for example, a central processing unit (CPU), a micro processing unit (MPU), a graphics processing unit (GPU), a field programmable gate array (FPGA), an application specific integrated circuit (ASIC), or an artificial intelligence (AI) chip.

The main storage device 12 is a device that stores programs and data, and is, for example, a read only memory (ROM), a random access memory (RAM), or a non volatile RAM (NVRAM).

The auxiliary storage device 13 is, for example, a solid state drive (SSD), a hard disk drive, an optical storage device (a compact disc (CD), a digital versatile disc (DVD), or the like), a storage system, an IC card, a reading/writing device of a recording medium such as an SD card or an optical recording medium, or a storage area of a cloud server. Programs and data can be read into the auxiliary storage device 13 via a reading device of a recording medium and the communication device 16. The programs and data stored in the auxiliary storage device 13 are read into the main storage device 12 as needed.

The input device 14 is an interface that receives an input from the outside, and is, for example, a keyboard, a mouse, a touch panel, a card reader, a pen input tablet, or a voice input device.

The output device 15 is an interface that outputs various types of information such as processing progress and processing results. The output device 15 is, for example, a display device (a liquid crystal monitor, a liquid crystal display (LCD), a graphic card, or the like) that visualizes the various types of information, a device (an audio output device (a speaker or the like)) that converts the various types of information into audio, or a device (a printing device or the like) that converts the various types of information into characters. For example, the information processing device 10 may input and output information to and from another device via the communication device 16.

The input device 14 and the output device 15 constitute a user interface that receives information from the user and presents information to the user.

The communication device 16 is a device that implements communication with another device. The communication device 16 is a wired or wireless communication interface that implements communication with another device via the communication medium such as a communication network, and is, for example, a network interface card (NIC), a wireless communication module, or a USB module.

For example, an operating system, a file system, a data base management system (DBMS) (a relational database, NoSQL, or the like), a key-value store (KVS), or the like may be introduced into the information processing device 10.

Each function of the ethicality diagnosis device 100 is implemented by the processor 11 reading and executing a program stored in the main storage device 12 or by hardware (FPGA, ASIC, AI chip, or the like) constituting the ethicality diagnosis device 100. The ethicality diagnosis device 100 stores the various types of information (data) described above as, for example, a database table or a file managed by the file system.

The invention is not limited to the embodiment described above, and various modifications can be made without departing from the gist of the invention. Thus, the embodiment described above is described in detail to facilitate understanding of the invention, and the invention is not necessarily limited to that which includes all the configurations described above. In addition, another configuration can be added to, deleted from, or replaced with a part of a configuration of each embodiment.

For example, the invention is not limited to a model in which the model 115 is trained by supervised learning, and is also applicable to a case in which the model 115 is a model trained by unsupervised learning.

A part or all of the configurations, functional units, processing units, processing methods, and the like described above may be implemented by hardware by, for example, designing with an integrated circuit. In addition, the above configurations, functions, and the like may be implemented by software by a processor interpreting and executing a program for implementing each function. Information such as a program, a table, and a file for implementing each function can be stored in a recording device such as a memory, a hard disk, and a solid state drive (SSD), or in a recording medium such as an IC card, an SD card, and a DVD.

Arrangements of the various functional units, various processing units, and various databases of the information processing device described above are merely examples. The arrangements of the various functional units, various processing units, and various databases may be changed to optimal arrangements from the viewpoint of performance, processing efficiency, communication efficiency, and the like of hardware and software provided in the device.

In addition, the configuration (schema, and the like) of the database storing the above-described various pieces of data may be flexibly changed from the viewpoint of efficient use of resources, improvement in processing efficiency, improvement in access efficiency, improvement in search efficiency, and the like.

### REFERENCE SIGNS LIST

100: ethicality diagnosis device
110: storage unit
111: input data
112: feature
113: correct label
114: training data
115: model
116: prediction result
117: per-feature importance level
118: selected feature
119: S feature
120: S feature data
121: S feature coefficient
122: prediction/diagnosis result
130: information acquisition and management unit
135: feature extraction unit
140: training data generation unit
145: model training unit
150: prediction unit
155: per-feature importance level calculation unit
160: feature selection unit
165: S feature data generation unit
170: S feature data analysis unit
175: ethicality diagnosis unit
180: prediction/diagnosis result output unit

1. An ethicality diagnosis device for diagnosing ethicality of a prediction result of an AI model, the device comprising:
an information processing device including a processor and a storage device, wherein
the information processing device stores
sensitive feature data which is data that associates a value of a sensitive feature, which is a feature required to take a certain consideration in handling from a perspective of the ethicality with a value of a selected feature, which is one or more features selected from a feature of the AI model,
a sensitive feature coefficient which is a value indicating a degree of impact of each of the selected features on the sensitive feature, which is obtained by analyzing a relationship between the value of the sensitive feature and the value of the selected feature, and
a per-feature importance level which is a value indicating a degree of impact of each of the selected features on a prediction result of the AI model, and
obtains, based on the sensitive feature coefficient and the per-feature importance level, a non-ethical degree, which is a value indicating a degree of ethicality of the prediction result output by the AI model.

2. The ethicality diagnosis device according to claim 1, wherein
the non-ethical degree is calculated by the following formula:
$$NON - ETHICAL DEGREE = 100 \times {\sum }_{i = 0}^{n} ( {L}_{i} \times {s}_{i} ) ,$$
where Lᵢ is a normalized per-feature importance level, sᵢ is an S feature coefficient, i is a natural number that identifies the S feature coefficient, and n is the number of selected features.

3. The ethicality diagnosis device according to claim 1, wherein
logistic regression analysis is performed on the sensitive feature data with the sensitive feature as an objective variable and the selected feature as an explanatory variable, thereby obtaining a regression variable as the sensitive feature coefficient.

4. The ethicality diagnosis device according to claim 3, wherein
a plurality of pieces of sensitive feature data having different combinations of the selected features are generated,
the logistic regression analysis is performed on each of the sensitive feature data,
a Matthews Correlation Coefficient (MCC) is obtained for each of the sensitive feature data by cross-validation, and
a regression coefficient obtained based on the sensitive feature data having a maximum MCC is selected as the sensitive feature coefficient.

5. The ethicality diagnosis device according to claim 3, wherein
when multicollinearity is present between the selected features, one of the selected features that is in a correlation relationship is excluded.

6. The ethicality diagnosis device according to claim 5, wherein
a variance inflation factor (VIF) is used as an index indicating whether the multicollinearity is present, and
when the VIF between the selected features exceeds a preset threshold value, it is determined that the multicollinearity is present between the selected features.

7. The ethicality diagnosis device according to claim 1, wherein
the per-feature importance level is obtained based on any one of “SHapley Additive explanations (SHAP)”, a “Shapley value”, a “Cohort Shapley value”, and “local permutation importance”.

8. The ethicality diagnosis device according to claim 1, further comprising a user interface configured to receive a setting of the sensitive feature.

9. The ethicality diagnosis device according to claim 1, further comprising a user interface configured to receive a setting of the sensitive feature data.

10. The ethicality diagnosis device according to claim 1, further comprising a user interface configured to output the obtained non-ethical degree or information based on the non-ethical degree.

11. The ethicality diagnosis device according to claim 1, further comprising a user interface configured to output the sensitive feature coefficient used for calculation of the non-ethical degree and the per-feature importance level.

12. The ethicality diagnosis device according to claim 1, further comprising a user interface configured to output a warning when a value of the non-ethical degree exceeds a preset threshold value.

13. An ethicality diagnosis method for diagnosing ethicality of a prediction result of an AI model, the method comprising:
a step of storing, by an information processing device including a processor and a storage device,
sensitive feature data, which is data that associates a value of a sensitive feature, which is a feature required to take a certain consideration in handling from a perspective of the ethicality with a value of a selected feature, which is one or more features selected from a feature of the AI model,
a sensitive feature coefficient which is a value indicating a degree of impact of each of the selected features on the sensitive feature, which is obtained by analyzing a relationship between the value of the sensitive feature and the value of the selected feature, and
a per-feature importance level, which is a value indicating a degree of impact of each of the selected features on a prediction result of the AI model; and
a step of obtaining, based on the sensitive feature coefficient and the per-feature importance level, a non-ethical degree, which is a value indicating a degree of ethicality of the prediction result output by the AI model.

14. The ethicality diagnosis method according to claim 13, further comprising a step of obtaining, by the information processing device, the non-ethical degree by the following formula:
$$NON - ETHICAL DEGREE = 100 \times {\sum }_{i = 0}^{n} ( {L}_{i} \times {s}_{i} ) ,$$
where Lᵢ is a normalized per-feature importance level, sᵢ is an S feature coefficient, i is a natural number that identifies the S feature coefficient, and n is the number of selected features.

15. The ethicality diagnosis method according to claim 13, further comprising a step of performing, by the information processing device, logistic regression analysis on the sensitive feature data with the sensitive feature as an objective variable and the selected feature as an explanatory variable to obtain a regression variable as the sensitive feature coefficient.
